(19) United States
(12) Patent Application Publication
(10) Pub. No.: US 2021/0065303 A1
(43) Pub. Date: Mar. 4, 2021

(54) SYSTEM AND METHOD FOR RAPID GENETIC ALGORITHM-BASED PORTFOLIO GENERATION

(71) Applicant: The Vanguard Group, Inc., Valley Forge, PA (US)

(72) Inventors: Roger Aliaga-Diaz, Penn Valley, PA (US); Harshdeep Ahluwalia, Coatesville, PA (US); Giulio Renzi-Ricci, London (GB)

(73) Assignee: The Vanguard Group, Inc.

(21) Appl. No.: 16/551,688

(22) Filed: Aug. 26, 2019

(51) Int. Cl. G06Q 40/06; G06Q 40/02

(52) U.S. Cl. CPC G06Q 40/06; G06Q 40/02

(57) ABSTRACT

Systems and methods for artificial intelligence-based computerized portfolio generation. For example, the genetic algorithm may be used to determine optimal portfolio allocations. In one embodiment, a method is disclosed. The method comprises receiving an electronic request for portfolio generation, the request comprising constraint data and risk tolerance data, retrieving performance and return data related to available investments, generating a set of portfolios based on the performance and return data, filtering the generated portfolios based on the received constraint data to determine a filtered set of portfolios. The method further comprises, for each of the filtered set of portfolios, calculating a plurality of returns for a portfolio using a genetic algorithm, and computing an expected utility score for each portfolio based on the received risk tolerance data. The method further comprises outputting investments associated with a portfolio having a highest expected utility score.

### TECHNICAL FIELD

The present disclosure relates generally to systems and methods for generating asset allocations in the form of a portfolio, and more particularly, to systems and methods that rapidly generate portfolios and associated asset distributions using artificial intelligence techniques, including genetic algorithms.

### BACKGROUND

Traditional methods of portfolio generation rely upon manual determination of investments such as stocks and bonds. Investors or managers determine an ideal mix of investments based on experience, past performance, and other factors such as acceptable levels of risk. But such manual solutions are subjective, time consuming and do not scale easily. For example, choosing investments manually takes skill and requires knowledge of complex markets, something that is difficult to do manually.

Computerized methods for portfolio generation were developed to speed up the process of generating portfolios. These computerized methods for portfolio generation take into account one type of risk (such as tolerance to systematic or “beta” risk), select investments, and iteratively modify the investments based on risk tolerance. These methods are inefficient and do not account for multiple types of risk simultaneously.

For example, prior computerized systems for portfolio generation do not proactively consider active risk data and/or risk tolerance data in the constructions of active-passive portfolios. Indeed, such prior computerized systems suffer from the problem of being too subjective as they rely on human input to finalize portfolio selection and do not appropriately account for human error (e.g., manager selection error).

The disclosed system and method for efficient portfolio generation address one or more of the problems set forth above and/or other problems in the prior art.

### SUMMARY

One aspect of the present disclosure is directed to a method for generating a portfolio. The method may comprise receiving, via a network, an electronic request for portfolio generation, the request comprising constraint data and risk tolerance data, the risk tolerance data comprising a plurality of types of risk data and retrieving, via the network, performance and return data related to available investments. The method may further comprise generating a set of portfolios based on the performance and return data and filtering the generated portfolios based on the received constraint data to determine a filtered set of portfolios. For each of the filtered set of portfolios, the method may comprise calculating a plurality of returns for a portfolio using a genetic algorithm and computing an expected utility score for each portfolio based on the received risk tolerance data. The method may further comprise outputting investments associated with a portfolio having a highest expected utility score.

Additional embodiments are envisioned and within the scope of the disclosure. For example, another aspect of the present disclosure is directed to a system for generating a portfolio. The system may comprise at least one processor and at least one storage device comprising instructions configured to cause the at least one processor to perform the above-discussed method.

Another aspect of the present disclosure is directed to a non-transitory and tangible computer-readable medium. The computer-readable medium may comprise instructions configured to cause at least one processor to perform the above-discussed method.

Other embodiments and variations thereon are discussed below in detail.

### BRIEF DESCRIPTION OF THE DRAWINGS

The accompanying drawings, which are incorporated in and constitute a part of this specification, illustrate disclosed embodiments and, together with the description, serve to explain the disclosed embodiments. In the drawings:

FIG. 1 is a block diagram of an exemplary system for efficient portfolio generation, consistent with disclosed embodiments.

FIG. 2 is an exemplary graph representing expected returns as a function of systematic risk aversion, based on mean-variance optimization.

FIG. 3A is an exemplary high-level flow chart illustrating a method of portfolio generation, consistent with disclosed embodiments.

FIG. 3B is exemplary graph representing expected returns as a function of systematic and alpha risk aversion, consistent with disclosed embodiments.

FIG. 4 is an exemplary user interface for receiving risk tolerance data and constraints from a user device, consistent with disclosed embodiments.

FIG. 5 is an exemplary flow chart illustrating a method of portfolio generation, consistent with disclosed embodiments.

FIG. 6 is a block diagram of an exemplary computing device, consistent with disclosed embodiments.

### DETAILED DESCRIPTION

The disclosure is generally directed to systems and methods for solving complex portfolio generation problems that allow for both deep client customization and large scale implementation and servicing. The disclosed systems and methods improve upon computerized systems and methods for portfolio generation by speeding up the process and improving compliance with input parameters, such as risk tolerance, using efficient optimization techniques such as genetic algorithms as well as other artificial intelligence techniques.

The disclosed systems and methods address the technical problems of slow and inefficient computerized portfolio generation. These features result in systems and methods that improve the efficiency of the computerized systems for generating portfolios, and result in more objectively based portfolios, minimizing potential errors as compared to more limited manual methods.

Reference will now be made in detail to the disclosed embodiments, examples of which are illustrated in the accompanying drawings.

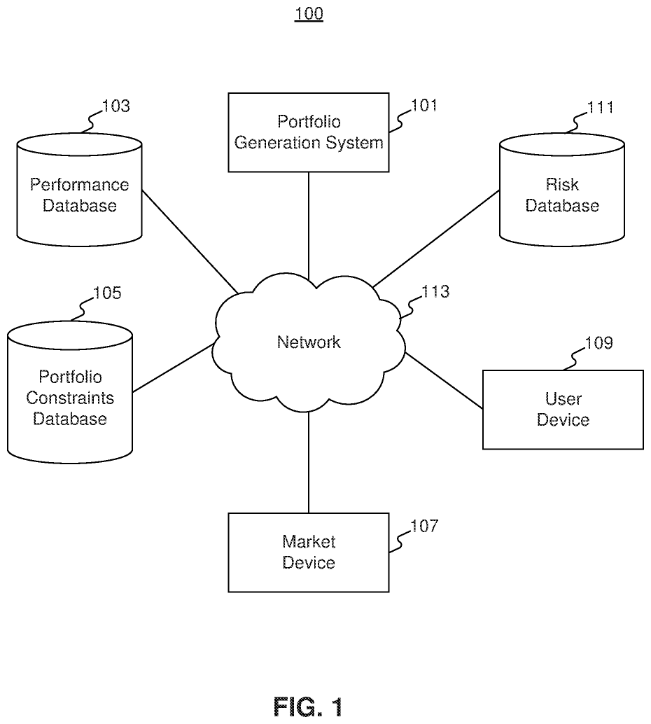

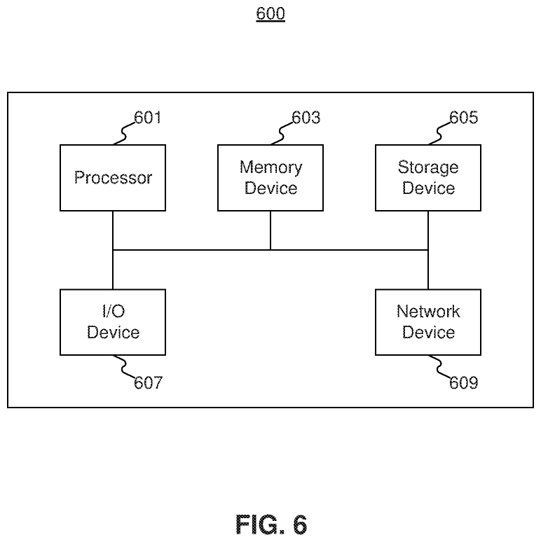

FIG. 1 is a block diagram of an exemplary system 100, consistent with disclosed embodiments. System 100 may be used to receive portfolio constraints and risk tolerance data, retrieve and/or calculate performance of assets for portfolio return estimation, generate portfolios, and create portfolios. System 100 may include a set of components, including a portfolio generation system 101, a performance database 103, a portfolio constraints database 105, a market device 107, a user device 109, a risk database 111, and a network 113. In some embodiments, system 100 may comprise one or more of each of the components in FIG. 1. For example, in one aspect, one implementation of system 100 may have one of each of portfolio generation system 101 and market device 107, and two or more of each other component (e.g., three user devices 109, five market devices 107, and so on). In some embodiments, one or more of the components in FIG. 1 may be implemented using computing device 600 (described below with respect to FIG. 6). In some embodiments, as shown in FIG. 1, components of system 100 may be connected to a network 113. However, in other embodiments components of system 100 may be connected directly with each other, without network 113.

Portfolio generation system 101, in some embodiments, may be implemented as a computing system for generating portfolios based on data received from one or more of performance database 103, portfolio constraints database 105, market device 107, user device 109, or risk database 111. As described in further detail below, portfolio generation system 101 may utilize data (such as constraints, risk data, and asset performance data) to generate possible portfolios, utilize a utility maximization function to generate scores for possible portfolios, determine the portfolio associated with a highest score, present the portfolio for consideration to user device 109, and initiate one or more trades associated with the portfolio via market device 107.

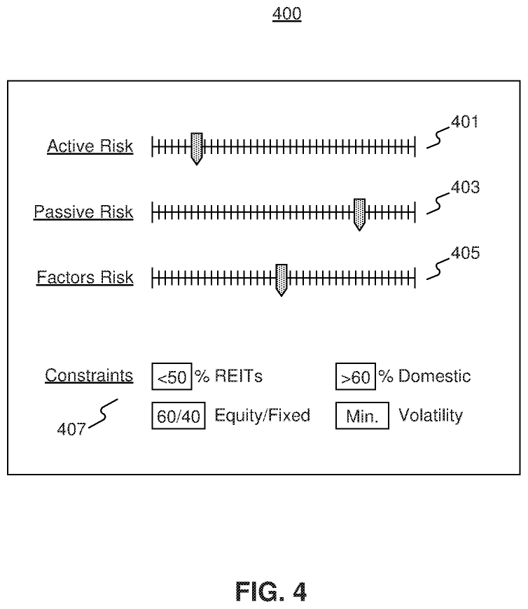

In some embodiments, portfolio generation system 101 may comprise a website, one or more web pages, one or more Application Programming Interfaces (APIs), or the like, enabling the receipt of input for portfolio generation (e.g., as discussed below with respect to FIG. 4).

Performance database 103, in some embodiments, may be implemented as a computing system comprising one or more databases. The databases may include data on expected returns for a set of assets that may be invested in as part of generating a portfolio, data on the set of assets (e.g., asset return forecast averages, distributions, and premia; standard deviations; factor returns and associated premia; and forecasted correlations across assets), data on active strategies and long-only factors (e.g., forecasted outperformance of active strategies), or the like.

Portfolio constraints database 105, in some embodiments, may be implemented as a computing system comprising one or more databases. The databases may include data on constraints for portfolio generation. For example, the data may include constraints received from user device 109 via a GUI (e.g., the user interface depicted in FIG. 4, described below). The constraints may include constraints on upper and/or lower bounds exposure. For example, user device 109 may provide data including constraints via network 113, such as constraints desire to generate portfolios with no more than 10% of assets allocated to Real Estate Investment Trusts (REITs), no more than 50% of fixed income allocation being provided by creditor assets, at least 60% of total equity allocation coming from domestic (e.g., US-based) equity investments, or the like. Other constraints are possible as well.

Market device 107, in some embodiments, may be implemented as a computing system for accessing one or more markets. For example, market device 107 may comprise a computing system providing data access with a stock market, a bond market, currency exchange markets, futures markets, commodities markets, and other kinds of markets. The data access may comprise, for example, providing information from market device 107 to portfolio generation system 101 or user device 109 about available investments (e.g., prices, volume, news), receiving instructions from portfolio generation system 101 or user device 109 (e.g., instructions to buy or sell investments), or the like. Market device 107 may provide data access using a variety of known protocols (such as FIX, FAST, HSVF, SAIL, SBE, UTP Direct, OUCH, ITCH, HTTP, FTP, Millennium) or other protocols in existence or that may be developed in the future.

User device 109, in some embodiments, may be implemented as a computing system. User device 109 may be one or more of a smartphone, a tablet, a phablet, a desktop, a laptop, a server, or the like. User device 109 may be configured to enable a user to input data including constraints and risk tolerance, and request the generation of one or more portfolios that comport with that data. For example, as described below with respect to FIG. 4, user device 109 may be configured to present an interface that receives input related to acceptable risk levels (e.g., active risk, passive risk, and factors risk) as well as input related to constraints (e.g., a minimum percentage of investments that should be allocated to fixed income investments).

Risk database 111, in some embodiments, may be implemented as a computing system comprising one or more databases. The databases, in some embodiments, may include data on levels of risk received from user device 109. For example, as discussed below, user device 109 may provide data relating to acceptable levels of risk for different types of investment risk, including active risk (indicating how averse an investor is to pursuing large potential gains over a benchmark like a market index), passive risk (indicating how averse an investor is to investing in risky assets, such as equities, as opposed to more conservative assets, such as fixed income investments), and factors risk (indicating how averse investors are to factor premia). In some embodiments, the acceptable levels of risk may be stored as whole number values (e.g., on a scale of 1-100), percentages (e.g., indicating a willingness to accept 30% of one kind of risk), letter grades (e.g., A-F), or the like. The form of the inputted risk value may not be the same as the stored form of that value. For example, in some embodiments, risk levels may be received as relative values (e.g., indicating that certain assets are “more” or “less” important) but stored as absolute numerical values (e.g., 58/100).

Performance database 103, portfolio constraints database 105, and risk database 111, in some embodiments, may include, for example, one or more of each of Oracle™ databases, Sybase™ databases, or other relational databases or non-relational databases, such as Hadoop™ sequence files, HBase™, or Cassandra™ Performance database 103, portfolio constraints database 105, and risk database 111 may include computing components (e.g., database management system, database server, etc.) configured to receive and process requests for data stored in memory devices of the database(s) and to provide data from the database(s). Furthermore, while performance database 103, portfolio constraints database 105, and risk database 111 are depicted separately from other components in FIG. 1, in some embodiments one or more of databases 103, 105, and 111 may be consolidated, omitted, or duplicated, or included in one or more of portfolio generation system 101, market device 107, or user device 109.

An illustrative example of system 100 follows. User device 109 may access a website hosted by portfolio generation system 101. User device 109 may utilize an interface to select risk tolerances and constraints for portfolio generation and may send that data to portfolio generation system 101. Portfolio generation system 101 may store risk tolerance data in risk database 111 and constraint data in portfolio constraints database 105. Portfolio generation system 101 may use information stored in performance database 103, portfolio constraints database 105, and risk database 111 to generate one or more portfolios, calculate return projections for each portfolio, and determine scores for each portfolio. Portfolio generation system 101 may send, through network 113, one or more instructions to market device 107 requesting market device 107 to purchase investments on behalf of a customer associated with user device 109.

FIG. 1 shows each of portfolio generation system 101, performance database 103, portfolio constraints database 105, market device 107, user device 109, risk database 111, and network 113 as different components. However, in some embodiments, one or more of these components may be consolidated into one or computing systems. For example, all elements in optimization system 105 may be embodied in a single server.

It is to be understood that the configuration and boundaries of the functional building blocks of system 100 have been defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

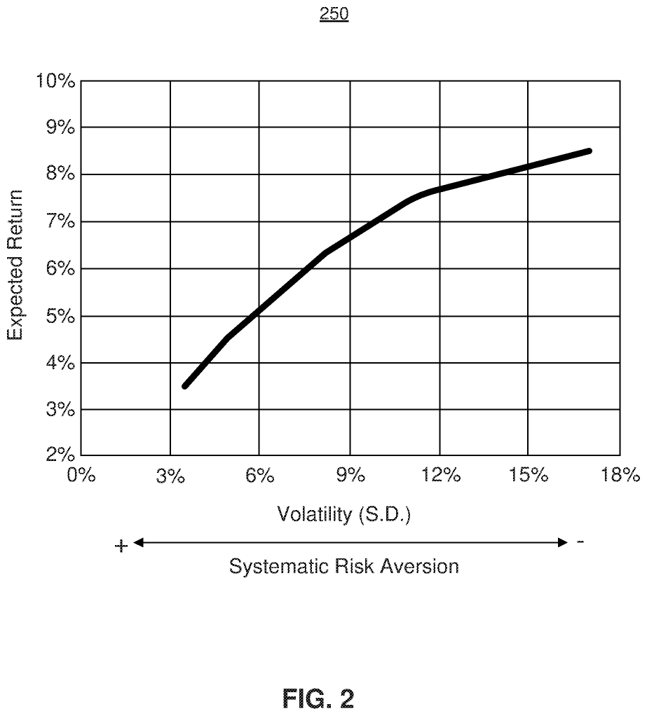

FIG. 2 is an exemplary graph 250 representing expected returns as a function of systematic risk aversion, based on mean-variance optimization, in the prior art. Graph 250 represents the results of a computerized portfolio generation method in the prior art.

Prior art techniques for portfolio generation typically follow a sequential process. These computer-implemented techniques, while straightforward, suffer from a number of problems as they do not solve for investment trade-offs that investors make (e.g., balancing between passive risk tolerance, active risk tolerance, and factor risk tolerance). These techniques generally operate by breaking the portfolio generation process into three steps.

The prior art solutions generally determine a passive allocation for a portfolio among broad asset classes such as stocks, funds, bonds, or the like. For example, the computing system may determine that 40% of the portfolio should be invested in stocks, 55% should be invested in mutual funds, and 5% should be held as cash.

After determining the passive allocation, the prior art solutions decide an allocation of sub-asset classes (e.g., assets defined by particular properties). As one example, equity assets may be divided into sub-asset classes. As another example, fixed income assets may be divided into sub-asset classes.

After allocating between sub-asset classes, the prior art solutions decide on a split between active and passive investment around a benchmark. For example, one passive benchmark may be a market index (e.g., S&P 500). The prior art solutions may then prepare instructions to instantiate the investment.

Prior art solutions suffer from technical problems. One example of such a problem is an inability to solve for investment trade-offs that investors face across different risk layers. Another technical problem is that such a method cannot accommodate for varying levels of alpha risk aversion, as prior art systems and methods require keeping that tolerance constant. Another technical problem is that processes like method 200 cannot properly account for critical information about potential investments, such as asset return expectations, volatilities, correlations, factor loadings, or tracking errors.

Graph 250 illustrates the simple relationship in such prior art portfolio generation methods between standard deviations of volatility (the x-axis) and the expected return of such a portfolio (the y-axis). The curve illustrates the simplistic nature of such prior art methods; these methods illustrate that an investor must accept a certain level of volatility in order to attain higher returns. The simple nature of graph 250 also illustrates the technical problems with known computerized methods; investors are limited into accepting a small variety of portfolios based on a limited set of inputs (i.e., because the only input that can be configured is the amount of volatility on the X-axis).

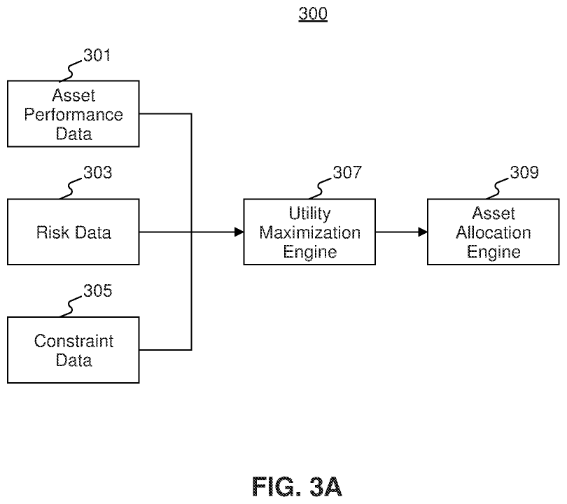

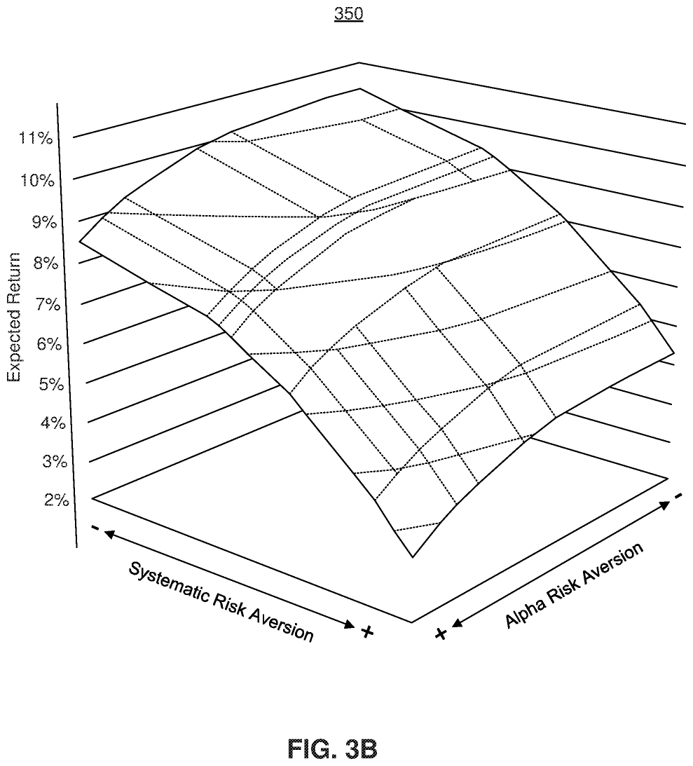

FIG. 3A is an exemplary high-level flow chart illustrating a method 300 of portfolio generation, consistent with disclosed embodiments. Method 300 represents a high-level process that is used with the disclosed embodiments to generate a portfolio for an investor (e.g., a user of user device 109) by determining simultaneous active-passive combinations across multiple asset classes, determining how the active-passive decision in one asset class impacts overall asset allocation, account for active manager's factor styles, determine how much to substitute active strategy with passive factor investment vehicles, and account for different investors' investment horizons and attitudes towards risk, among other goals.

Asset performance data 301 may be data representing performance of particular assets. The data may include expected returns for a set of assets that may be invested in as part of generating a portfolio, data on volatility and correlations of the set of assets, data on active strategies and long-only factors, or the like. In some embodiments, asset performance data 301 may be stored in the form of MATLAB files, but not all embodiments require or use this type of file to store such data.

Asset performance data 301 may be, in some embodiments, generated by an engine that takes in current market and economic conditions and past performance of assets, and generates forward-looking return assumptions based on non-normal distributions. For example, a computing system (e.g., portfolio generation system 101) may generate forecasts using a probabilistic (distributional) framework to simulate multiple paths of future returns. In some embodiments, these paths may all begin from the same initial economic and financial market conditions, and each followed path is output as one possible outcome for a particular set of investments. In some embodiments, the engine uses many data points to estimate a dynamic statistical relationship between risk factors and asset returns. The engine may then use the relationship with regression-based Monte Carlo techniques to determine future outcomes based on those relationships. The engine may utilize such techniques to create multiple potential paths for asset returns.

In some embodiments, the output of such an engine may comprise distributions of asset returns, volatilities, and correlations. In some embodiments, the simulation engine system for generating asset performance data 301 may provide forecasts for asset returns, such as 10-year asset forecasts, by simulating multiple combinations of different types of risk data (described below).

Risk data 303, in some embodiments, comprises data provided by an investor (e.g., using interface 400, described below, with user device 109 in FIG. 1) indicating acceptable levels of risk for different types of investment risk. Risk data 303 may include different types of risk; for example, risk data 303 may include data representing levels of risk associated with one or more investors using user device 109.

One type of data in risk data 303 is referred to as “active risk.” Active risk data in risk data 303 may represent an investor's tolerance for risk of underperformance on individual assets that are chosen or invested in by an active manager (e.g., a human manager or a computerized manager). Investors with a high level of active risk tolerance expect outperformance relative to passive alternatives such as fixed-income investments, and such a tolerance may be stored in risk data 303 as a positive factor-adjusted alpha expectation. However, it is possible for active investments to underperform passive investments.

Another type of data in risk data 303 is referred to as “systematic risk” or “passive risk.” Systematic risk data in risk data 303 may represent an investor's tolerance in investing in riskier assets (such as equities) as opposed to investing in less risky assets (such as fixed income assets).

Another type of data in risk data 303 is referred to as “factor risk.” Factor risk data in risk data 303 may represent an investor's tolerance to investing in investments based on factors. Factors may include value; some investors may be of the opinion that undervalued stocks outperform expensive ones. Other factors may include volatility, size, and momentum. Factor may be associated with risk premia, which relate to higher rates of return (with risk). The momentum factor (i.e., investments that continue to move tend to continue to move in a positive direction) is often weakly (or not) correlated often to value, size and low volatility, and thus performs well when those factors are not performing.

In some embodiments, risk data 303 may comprise data representing different types of risk, be stored as whole number values (e.g., on a scale of 1-5), percentages (e.g., indicating a willingness to accept 30% of one kind of risk), letter grades (e.g., A-F), or the like. Risk data 303 may be input in a variety of ways. In some embodiments, FIG. 4 (described below) is an exemplary interactive tool usable for input of such data. In other embodiments, risk data 303 may be input using electronic online real-time surveys or revealed preference systems (e.g., determining a unique risk aversion level based on received investment preferences).

Constraint data 305, in some embodiments, comprises data provided by an investor (e.g., using interface 400, described below, with user device 109 in FIG. 1) regarding various constraints on the types of investments in a portfolio for the investor. For example, constraint data may include constraints on upper and/or lower bounds exposure, such as portfolios with no more than 10% of assets allocated to Real Estate Investment Trusts (REITs), no more than 50% of fixed income allocation being provided by creditor assets, at least 60% of total equity allocation coming from domestic (e.g., US-based) equity investments, or the like. Other constraints are possible as well.

In some embodiments, each of asset performance data 301, risk data 303, and constraint data 305 may be stored in one or more databases (e.g., performance database 103, risk database 111, and portfolio constraints database 105, respectively).

Utility maximization engine 307 may receive each of asset performance data 301, risk data 303, and constraint data 305 (e.g., from databases 103, 111, and 105 in FIG. 1, respectively), and determine the individual expected utility scores of each type of risk from risk data 303. For example, utility maximization engine 307 may utilize each risk aversion value γₐ, γₚ, and γ_{f} (active risk value, systematic risk value, and factor risk value, respectively) as part of a power utility function to model preference and attitude towards risk, as

$$U ( W ) = \{ \begin{matrix}\frac{{W}^{1 - γ}}{1 - γ} , & γ > 1 \\ ln ( W ) , & γ = 1\end{matrix}$$

where:

γ is the relative risk aversion (RRA) coefficient, and

W is the level of terminal wealth relative to starting wealth.

The investor determining what to invest wealth W₀ in over investment horizon T expects to receive

$$\frac{{W}_{T}}{{W}_{0}} ,$$

which is calculated as Equation (1) below:

$$\frac{{W}_{T}}{{W}_{0}} = ( 1 + {R}_{T} ) ≅ {\prod }_{t = 1}^{T} {e}^{{R}_{t}} = {e}^{{\sum }_{t = 1}^{T} {R}_{t}}$$

where Rₜ is the total return of a multi-asset portfolio at time t. Rₜ is calculated as Equation (2) below:

$${\sum }_{i = 1}^{N} {w}_{i} {r}_{i , t} = {\sum }_{i = 1}^{N} {w}_{i}^{p} {r}_{i , t}^{p} + {\sum }_{i = 1}^{N} {\sum }_{f = 1}^{F} {w}_{i}^{f} {r}_{i , t}^{f} + {\sum }_{i = 1}^{N} {w}_{i}^{a} {r}_{i , t}^{a}$$

where:

r_{i,t}^{p}=r_{i,t}^{M},

r_{i,t}^{f}=r_{i,t}^{M}+δ_{i,t}^{f},

r_{i,t}^{α}=αᵢ+βᵢr_{i,t}^{M}+Σ_{f=1}^{F}Lᵢ^{f}δ_{i,t}^{f}+ε_{i,t}, and

ε_{i,t}˜t(v)\sqrt{σ_{α}_{ᵢ}²}

In the above equations:
a. wᵢ and rᵢ are the portfolio weights and relative total returns for each asset class i;
b. superscripts p, f, and a refer to passive, factors and active, respectively;
c. market benchmark return is r_{i,t}^{M};
d. δᵢ^{f} is the excess (based on the market benchmark) factor return for factor f;
e. βᵢ and Lᵢ correspond to the market beta and factor loading for each asset class, respectively;
αᵢ is the net (i.e., factor-adjusted) excess active return

Equations (1) and (2) can be developed and rearranged as Equation (3) below:

$$\frac{{W}_{T}}{{W}_{0}} = {e}^{{\sum }_{t = 1}^{T} {R}_{t}} = {e}^{{\sum }_{t = 1}^{T} {R}_{p , t} + {R}_{f , t} + {R}_{a , t}}$$

$$\{ \begin{matrix}{R}_{p , t} = {\sum }_{i = 1}^{N} [ ( {w}_{i}^{p} + {\sum }_{f = 1}^{F} {w}_{i}^{f} + {w}_{i}^{a} ) {r}_{i , t}^{M} ] \\ {R}_{f , t} = {\sum }_{i = 1}^{N} [ ( {\sum }_{f = 1}^{F} {L}_{i}^{f} {δ}_{i , t}^{f} + ( {β}_{i} - 1 ) {r}_{i , t}^{M} ) {w}_{i}^{a} + {\sum }_{f = 1}^{F} {w}_{i}^{f} {δ}_{i , t}^{f} ] \\ {R}_{a , t} = {\sum }_{i = 1}^{N} {w}_{i}^{a} ( {α}_{i} + {ɛ}_{i , t} )\end{matrix}$$

which can be rewritten as Equation (4):

$$\frac{{W}_{T}}{{W}_{0}} = {e}^{{\sum }_{t = 1}^{T} {R}_{p , t} + {R}_{f , t} + {R}_{a , t}} = {e}^{{R}_{p , T} + {R}_{f , T} + {R}_{a , T}}$$

The utility based optimization problem can then be recast as Equation (5) below:

$${max}_{w} 𝔼 [ U ( \frac{{W}_{T}}{{W}_{0}} ) ] \to {max}_{w} \{ 𝔼 [ \frac{{W}_{p}^{1 - {γ}_{p}}}{1 - {γ}_{p}} ] + 𝔼 [ \frac{{W}_{f}^{1 - {γ}_{f}}}{1 - {γ}_{f}} ] + 𝔼 [ \frac{{W}_{a}^{1 - {γ}_{a}}}{1 - {γ}_{a}} ] \}$$

$$s . t . \{ {w}_{i} ∈ ℝ \vert 0 \leq {w}_{i} \leq 1 \} ⋀ {\sum }_{i} {w}_{i} = 1$$

$${\sum }_{i} C \cdot {w}_{i} \leq b$$

where:
Wₚ, Wₚ and Wₚ are the wealth at maturity coming from systematic, net alpha and factor exposures, respectively;
Wₚ=e^{R}^{_{p,T}}, W_{f}=e^{R}^{_{f,T}} and Wₐ=e^{R}^{_{α,T}}; and
αₐ, γₚ, and γ_{f} represent active risk value, systematic risk value, and factor risk value, respectively.

Utility maximization function 307 may then also optimize portfolio weights using a variety of techniques. For example, in some embodiments, utility maximization function 307 may be implemented as a genetic algorithm. In such embodiments, utility maximization function may determine optimal values for each of the above values by repeatedly calculating the value of Formula (5) above for a set of input values, selecting a number of “best” solutions from the calculated values, and using the values to generate a number of possible additional solutions and calculating the value of Formula (5) for those additional solutions. The utility maximization function 307 may be used until an ideal solution is found (e.g., because the repeated use of the function on different values no longer produces better results than earlier runs of the function).

Upon determining the ideal portfolio weights, asset allocation engine 309 may allocate the portfolio.

FIG. 3B is exemplary graph 350 representing expected returns based on different inputs associated with systematic and alpha risk aversion, consistent with disclosed embodiments. In contrast to FIG. 2, where only systematic risk aversion may be accounted for (as a function of volatility), graph 350 represents, in some embodiments, thousands of possible portfolios, using three dimensions to represent systematic risk aversion, alpha risk aversion, and the expected return for each optimal portfolio at each level of risk aversion.

FIG. 4 is an exemplary interactive tool, as a user interface 400, for receiving risk tolerance data and constraints from a user device, such as user device 109, consistent with disclosed embodiments. A user may interact with user interface 400 to input information (as well as to see information and make further adjustments) that may be stored in various databases (e.g., performance database 103 and risk database 111), sent to portfolio generation system 101 via network 113, stored on user device 109, or otherwise used by components of system 100.

Active risk widget 401 provides a slider widget for a user using user device 109 to input a value associated with a tolerable level of active risk. User device 109 may send this value to portfolio generation system 101 and/or risk database 111. For example, in exemplary FIG. 4, a user has dragged the slider to roughly the 20% mark.

Passive risk widget 403 provides a slider widget for a user using user device 109 to input a value associated with a tolerable level of systematic or passive risk. User device 109 may send this value to portfolio generation system 101 and/or risk database 111. For example, in exemplary FIG. 4, a user has dragged the slider to roughly the 80% mark.

Factors risk widget 405 provides a slider widget for a user using user device 109 to input a value associated with a tolerable level of factors risk. User device 109 may send this value to portfolio generation system 101 and/or risk database 111. For example, in exemplary FIG. 4, a user has dragged the slider to roughly the 50% mark.

Constraints widget 407 comprise a series of input boxes for a user using user device 109 to input one or more values associated with various constraints for portfolio generation. User device 109 may send this value to portfolio generation system 101 and/or portfolio constraints database 105. For example, in exemplary FIG. 4, a user has input that the portfolios should have less than 50% of assets in REITs, more than 60% in domestic investments, a 60/40 balance between equity investments and fixed income investments, and a desire to minimize volatility.

Active risk interface widget 401, passive risk interface widget 403, and factors risk interface widget 405 are represented in FIG. 4 as slider widgets, and constants 407 are represented as input box widgets; these depictions are exemplary in nature and other types of user interface elements are possible (e.g., drop-down boxes, radio buttons, spinners, menus, icons, combo boxes, or check boxes).

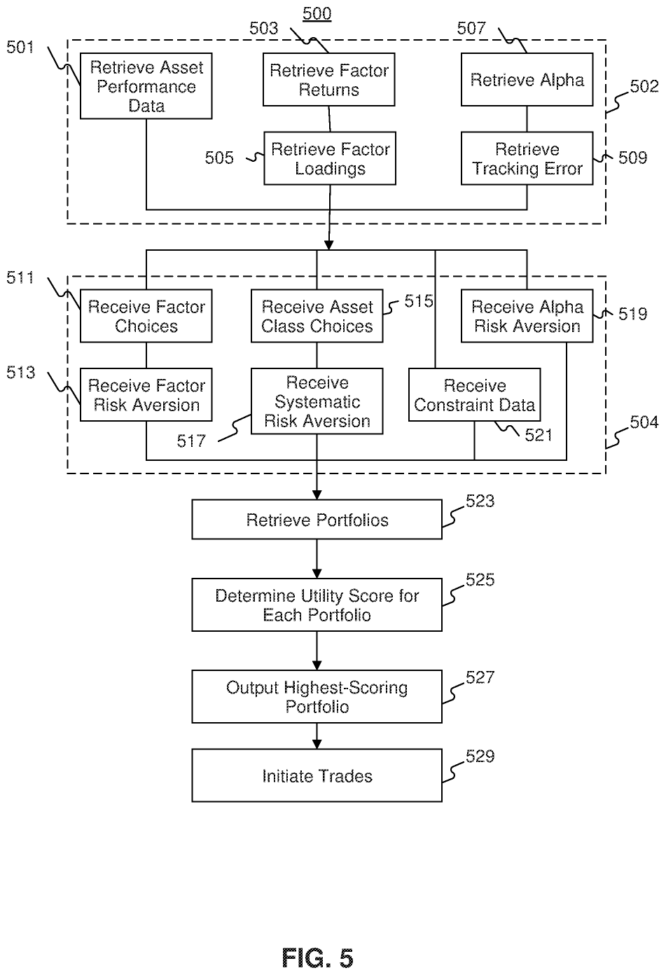

FIG. 5 is an exemplary flow chart illustrating a method 500 of portfolio generation, consistent with disclosed embodiments. In one aspect, method 500 represents a detailed implementation of the embodiments described above with respect to FIG. 3A.

Method 500 begins with dynamic performance assessment step 502. Step 502 comprises sub-steps 501, 503, 505, 507, and 509. In some embodiments, one of more of the sub-steps of step 502 may be performed sequentially. In some embodiments one of more of the sub-steps of step 502 may be performed in parallel.

In step 501, portfolio generation system 101 may retrieve or calculate asset performance data. For example, portfolio generation system 101 may retrieve data from a database, such as performance database 103. As discussed above with respect to FIGS. 1 and 3A, the data may comprise data representing performance of particular assets. The data may include expected returns for a set of assets that may be invested in as part of generating a portfolio, data on volatility and correlations of the set of assets, data on active strategies and long-only factors, or the like. The data may be generated by an engine that generates assumptions on returns based on non-normal distributions using a probabilistic (distributional) framework, by determining a relationship between risk factors and asset returns, and use that relationship with regression-based Monte Carlo techniques to determine future outcomes based on those relationships.

In step 503, portfolio generation system 101 may retrieve or calculate factor returns (rᵢ^{f} for each asset class i, in the equations described above with respect to FIG. 3A). For example, portfolio generation system 101 may retrieve data from a database, such as performance database 103. Factor returns may comprise, for example, the amount of return (e.g., a gain in the value of an asset) attributable to a particular common factor. For example, looking at a universe of assets, portfolio generation server 101 may determine the amount of value gained (or lost) in an asset that is attributable to a particular factor by decomposing asset returns into common factor components.

In step 505, portfolio generation system 101 may retrieve or calculate factor loadings (Lᵢ for each asset class i, in the equations described above with respect to FIG. 3A). Factor loading, in some embodiments, represents the relationship or “exposure” of a variable to an underlying factor. For example, the factor loading may comprise coefficients related to a manager, estimated based on past performance data for that manager.

In step 507, portfolio generation system 101 may retrieve or calculate alpha data (αᵢ for each asset class i, in the equations described above with respect to FIG. 3A). In some embodiments, alpha data may represent factor-adjusted excess returns over a benchmark (e.g., a market index).

In step 509, portfolio generation system 101 may retrieve or calculate tracking error data. Tracking error data may comprise the measure of a risk that is due to decisions made by an active manager (e.g., a person or team of people managing investments such as funds). The tracking error data may be calculated (e.g., by portfolio generation system 101) based on statistical regression of an active manager historical performance.

Dynamic constraint and risk assessment step 504 follows step 502 in method 500. Dynamic constraint and risk assessment step 504 comprises sub-steps 511, 513, 515, 517, 519, and 521. In some embodiments, one of more of the sub-steps of step 504 may be performed sequentially. In some embodiments one of more of the sub-steps of step 504 may be performed in parallel.

In step 511, user device 109 may send, via network 113, data relating to factor choices. For example, a user at user device 109 may utilize a user interface (e.g., user interface 400 in FIG. 4) to select particular factors for investing. As discussed above with respect to FIG. 4, a user may indicate via user interface 400 that she is averse to volatility or large companies, or that she desires to invest in investments with momentum as a factor.

In step 513, user device 109 may send, via network 113, data relating to factor risk aversion (γ_{f} in the equations described above with respect to FIG. 3A). For example, a user at user device 109 may utilize a user interface (e.g., user interface 400 in FIG. 4) to select a value for desired factor risk aversion. As discussed above, the data relating to factor risk aversion may represent, for example, the tolerance that a user has to investing in investments based on factors.

In step 515, user device 109 may send, via network 113, data relating to asset class choices. For example, a user at user device 109 may utilize a user interface (e.g., user interface 400 in FIG. 4) to select particular asset classes for investing. As discussed above, a user may indicate via user interface 400 that she wants to invest 40% of her portfolio in fixed-income assets and 60% of her portfolio in stocks. Other asset choices are possible as well.

In step 517, user device 109 may send, via network 113, data relating to systematic or passive risk aversion (γₚ in the equations described above with respect to FIG. 3A). For example, a user at user device 109 may utilize a user interface (e.g., user interface 400 in FIG. 4) to select a value for desired systematic risk aversion. As discussed above, the data relating to systematic risk aversion may represent, for example, the user's tolerance in investing in riskier assets (such as equities) as opposed to investing in less risky assets (such as fixed income assets).

In step 519, user device 109 may send, via network 113, data relating to alpha risk aversion (γₐ in the equations described above with respect to FIG. 3A). For example, a user at user device 109 may utilize a user interface (e.g., user interface 400 in FIG. 4) to select a value for desired alpha risk aversion. As discussed above, the data relating to systematic risk aversion may represent, for example, the user's tolerance in investing in riskier assets (such as equities) as opposed to investing in less risky assets (such as fixed income assets).

In step 521, user device 109 may send, via network 113, data relating to constraints. For example, a user at user device 109 may utilize a user interface (e.g., user interface 400 in FIG. 4) to select a desired constraints. As discussed above, constraints may comprise different limitations placed on the types of investments that a user wants to have in her portfolio. For example, a user may desire to have no more than 10% of assets in REITs, or may desire to have more than 40% of assets in B corporations.

In some embodiments, steps 502 and 504 (and associated sub-steps) may be performed in parallel or in sequence to one another. For example, portfolio generation system 101 may retrieve factor returns in step 503 substantially simultaneously as each of the sub-steps of step 504.

After performing steps 502 and 504, method 500 moves to step 523. In step 523, portfolio generation system 101 may retrieve a set of portfolios that are based on constraint data received in step 521. In some embodiments, portfolio generation system 101 may retrieve a set of possible portfolios, and iteratively consider each portfolio to exclude those that do not comport with the received constraint data.

After performing step 523, method 500 moves to step 525. In step 525, portfolio generation system 101 may compute a score for each portfolio (e.g., using Formula (5) above to optimize the portfolio).

After performing step 525, method 500 moves to step 527. In step 527, portfolio generation system 101 may output a portfolio with a highest utility score. Outputting the portfolio may comprise, for example, sending instructions to market device 107 to purchase investments in order to establish the portfolio, sending data relating to the selected investments to user device 109, or the like.

After performing step 527, method 500 moves to step 529. In step 529, market device 107 may receive instructions from portfolio generation system 101 and/or user device 109 to initiate the trades necessary to purchase investments chosen for the generated portfolio

FIG. 6 is a block diagram of an exemplary computing device 600, consistent with disclosed embodiments.

In some embodiments, computing device 600 may include one or more processors 601, one or more memory devices 603, one or more storage devices 605, one or more input/output (I/O) devices 607, and one or more network devices 609. In some embodiments, computing device 600 may take the form of mobile computing devices such as smartphones or tablets, general purpose computers, or any combination of these components. While depicted in singular form in FIG. 6, in some embodiments, each of the components in computing device 600 may be duplicated, omitted, or combined.

Processor 601 may include one or more known processing devices, such as mobile device microprocessors manufactured by Intel™, NVIDIA™, or various processors from other manufacturers.

Memory device 603 may include one or more storage devices configured to store instructions used by processor 601 to perform functions related to disclosed embodiments. In some embodiments, memory device 603 may be implemented as Random Access Memory (RAM), flash memory, or the like. For example, memory device 603 may be configured with one or more software instructions that perform operations when executed by processor 601. The disclosed embodiments are not limited to separate programs or computers configured to perform dedicated tasks. For example, memory device 603 may include a single program that generates portfolios or may include multiple programs that generate portfolios, consistent with the disclosed embodiments.

Storage device 605 may include one or more storage devices configured to store data consistent with the disclosed embodiments. In some embodiments, memory device 603 may be implemented as a hard disk, flash memory, or the like. For example, memory device 603 may include constraint data or risk tolerance data, consistent with the disclosed embodiments.

I/O device 607 may include one or more devices configured to allow data to be received and/or transmitted by computing device 600. For example, I/O device 607 may comprise input devices such as a keyboard, a mouse, a touchscreen, a microphone, or a camera, as well as systems and components configured to enable those devices to provide input to computing device 600 (e.g., USB ports and associated chipset). I/O device 607 may also comprise output devices such as a monitor, a printer, or speakers, as well as systems and components configured to enable those devices to provide input to computing device 600 (e.g., a graphics card/chipset, sound card, and USB ports and associated chipset). I/O device 607 may also include other components known in the art for interacting other components of system 100 in FIG. 1.

Network device 609 may include one or more devices configured to communicate data to other components of system 100. For example, network device 609 may comprise a device enabling communication via network 113, including via wireless or wired means, such as a cellular modem, an Ethernet adapter, a wireless network adapter (e.g., IEEE 802.11), or the like.

Each component depicted in FIG. 6 may be connected to each other directly or via one or more computing buses. The components of computing device 600 may be implemented in hardware, software, firmware, or a combination, as will be apparent to those skilled in the art. A computing system, as used herein, may comprise one or more computing devices 600 (e.g., in a cluster of devices).

Another aspect of the disclosure is directed to a non-transitory computer-readable medium storing instructions that, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage unit or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed system and related methods. Other embodiments will be apparent to those skilled in the art from consideration of the specification and practice of the disclosed system and related methods. It is intended that the specification and examples be considered as exemplary only, with a true scope being indicated by the following claims and their equivalents.

Moreover, while illustrative embodiments have been described herein, the scope thereof includes any and all embodiments having equivalent elements, modifications, omissions, combinations (e.g., of aspects across various embodiments), adaptations and/or alterations as would be appreciated by those in the art based on the present disclosure. For example, the number and orientation of components shown in the exemplary systems may be modified. Further, with respect to the exemplary methods illustrated in the attached drawings, the order and sequence of steps may be modified, and steps may be added or deleted.

Thus, the foregoing description has been presented for purposes of illustration only. It is not exhaustive and is not limiting to the precise forms or embodiments disclosed. Modifications and adaptations will be apparent to those skilled in the art from consideration of the specification and practice of the disclosed embodiments.

What is claimed is:

1. A computerized system for generating a portfolio, comprising:
at least one processor; and
at least one storage device comprising instructions configured to cause the at least one processor to perform a method, the method comprising:
receiving, via a network, an electronic request for portfolio generation, the request comprising constraint data and risk tolerance data, the risk tolerance data comprising a plurality of types of risk data;
retrieving, via the network, performance and return data related to available investments;
generating a set of portfolios based on the performance and return data;
filtering the generated portfolios based on the received constraint data to determine a filtered set of portfolios;
for each of the filtered set of portfolios:
calculating a plurality of returns for a portfolio using a genetic algorithm, and
computing an expected utility score for each portfolio based on the received risk tolerance data; and
outputting investments associated with a portfolio having a highest expected utility score.

2. The system of claim 1, wherein receiving the request for portfolio generation comprises receiving the request via one of a webpage, a website, or an API.

3. The system of claim 2, wherein the request is received from a user device, and further wherein outputting the investments associated with the portfolio having a highest expected utility score comprises sending, via the network, one of portfolio information to the user device or investing instructions to a market device.

4. The system of claim 1, wherein the risk tolerance data comprises at least one of alpha risk tolerance data, factor risk tolerance data, and systematic risk tolerance data.

5. The system of claim 1, wherein the constraint data comprises limitations on types of investments or limitations on proportions of investments.

6. The system of claim 1, further comprising simultaneously calculating a plurality of returns for each portfolio for a plurality of the filtered set of portfolios.

7. The system of claim 1, wherein the plurality of returns is calculated by optimizing over alpha risk tolerance data, factor risk tolerance data, and systematic risk tolerance data.

8. A computerized method for generating a portfolio, comprising:
receive, via a network, an electronic request for portfolio generation, the request comprising constraint data and risk tolerance data, the risk tolerance data comprising a plurality of types of risk data;
retrieve, via the network, performance and return data related to available investments;
generate, using at least one processor, a set of portfolios based on the performance and return data;
filter, using the at least one processor, the generated portfolios based on the received constraint data to determine a filtered set of portfolios;
for each of the filtered set of portfolios:
calculate, using the at least one processor, a plurality of returns for a portfolio using a genetic algorithm, and
compute, using the at least one processor, an expected utility score for each portfolio based on the received risk tolerance data; and
output, via the network and using the processor, investments associated with a portfolio having a highest expected utility score.

9. The method of claim 8, wherein receiving the request for portfolio generation comprises receiving the request via one of a webpage, a website, or an API.

10. The method of claim 9, wherein the request is received from a user device, and further wherein outputting the investments associated with the portfolio having a highest expected utility score comprises sending, via the network, one of portfolio information to the user device or investing instructions to a market device.

11. The method of claim 8, wherein the risk tolerance data comprises at least one of alpha risk tolerance data, factor risk tolerance data, and systematic risk tolerance data.

12. The method of claim 8, wherein the constraint data comprises limitations on types of investments or limitations on proportions of investments.

13. The method of claim 8, further comprising simultaneously calculating a plurality of returns for each portfolio for a plurality of the filtered set of portfolios.

14. The method of claim 8, wherein the plurality of returns is calculated by optimizing over alpha risk tolerance data, factor risk tolerance data, and systematic risk tolerance data.

15. A tangible, non-transitory computer-readable medium comprising instructions configured to cause at least one processor to perform a method, the method comprising:
receive, via a network, an electronic request for portfolio generation, the request comprising constraint data and risk tolerance data, the risk tolerance data comprising a plurality of types of risk data;
retrieve, via the network, performance and return data related to available investments;
generate a set of portfolios based on the performance and return data;
filter the generated portfolios based on the received constraint data to determine a filtered set of portfolios;
for each of the filtered set of portfolios:
calculate a plurality of returns for a portfolio using a genetic algorithm, and
compute an expected utility score for each portfolio based on the received risk tolerance data; and
output investments associated with a portfolio having a highest expected utility score.

16. The medium of claim 15, wherein receiving the request for portfolio generation comprises receiving the request via one of a webpage, a website, or an API.

17. The medium of claim 16, wherein the request is received from a user device, and further wherein outputting the investments associated with the portfolio having a highest expected utility score comprises sending, via the network, one of portfolio information to the user device or investing instructions to a market device.

18. The medium of claim 15, wherein the plurality of returns is calculated by optimizing over alpha risk tolerance data, factor risk tolerance data, and systematic risk tolerance data.

19. The medium of claim 15, wherein the constraint data comprises limitations on types of investments or limitations on proportions of investments.

20. The medium of claim 15, further comprising simultaneously calculating a plurality of returns for each portfolio for a plurality of the filtered set of portfolios.
